(19) United States
(12) Patent Application Publication
(10) Pub. No.: US 2011/0187763 A1
(43) Pub. Date: Aug. 4, 2011

(54) DISPLAY AND COMPUTER READABLE MEDIUM

(75) Inventors: Masaki NOSE, Kawasaki (JP); Makoto Fukuda, Kawasaki (JP); Tsuneo Watanuki, Kawasaki (JP)

(73) Assignee: Fujitsu Limited, Kawasaki (JP)

(21) Appl. No.: 13/085,704

(22) Filed: Apr. 13, 2011

Related U.S. Application Data
(63) Continuation of application No. PCT/JP2008/071978, filed on Dec. 3, 2008.

(51) Int. Cl. G09G 3/36; G09G 5/10

(52) U.S. Cl. 345/690; 345/89

(57) ABSTRACT

A display includes: an image data storage unit that stores image data; a display image data generation unit that synthesizes the image data with data of a noise pattern image with no correlation to the image data, and generates display image data; and a display unit that displays an image based on the display image data generated by the display image generation unit, and maintains a display without power supply.

### CROSS-REFERENCE TO RELATED APPLICATION

This application is a continuation application of PCT/JP2008/071978 filed Dec. 3, 2008, the contents of which are herein wholly incorporated by reference.

### FIELD

A certain aspect of the embodiments discussed herein is related to a display and a computer readable medium.

### BACKGROUND

Recently, various enterprises and universities are actively engaged in the development of electronic paper. Multiple ways of application of electronic paper, such as electronic books, sub-displays of mobile terminals, displays of IC cards and the like, are proposed. One of display methods for electronic paper is cholesteric liquid crystals utilizing liquid crystal compositions which form a cholesteric phase. Cholesteric liquid crystals are also called chiral nematic liquid crystals, and are liquid crystals where molecules of nematic liquid crystals form a helical cholesteric phase by adding relatively large amount (several tens percent) of chiral additives (chiral materials) to nematic liquid crystals. Cholesteric liquid crystals have excellent features, such as memory characteristics capable of maintaining a display semi-permanently, vivid color display characteristics, high-contrast characteristics, high-resolution characteristics and the like.

More specifically, cholesteric liquid crystals have bi-stability (memory characteristics), and take one of a planer state, a focal conic state, and an intermediate state where a planer state and a focal conic state coexist, by adjusting the intensity of electric field applied to liquid crystals. Once the liquid crystal enters a planar state or a focal conic state, the state is thereafter kept with stability even when no electric power is supplied.

A planer state is obtained by applying a predetermined high voltage to a liquid crystal to apply a strong electric field to the same and thereafter nullifying the electronic field abruptly. For example, a focal conic state is obtained by applying a predetermined voltage lower than the above-described high voltage to the liquid crystal to apply an electric field to the same and thereafter nullifying the electric field abruptly. The intermediate state where a planer state and a focal conic state coexist is obtained by, for example, applying a voltage lower than the voltage for obtaining the focal conic state to the liquid crystal to apply an electric field to the same and thereafter nullifying the electric field abruptly.

A liquid crystal display element utilizing cholesteric liquid crystals has display memory characteristics as described above, and is good for being used to memory-display a same image for long period of time. However, if the liquid crystal display element displays an image for long period of time, when a rewrite is carried out to display a next image, there is a possibility of the occurrence of so-called image sticking, which means that the previously displayed image sticks as an after-image.

Affinity between moisture, ionic impurities or liquid crystals and substrate interfaces and the like are considered as the cause of image sticking. In order to prevent image sticking, very high stability is required in the degree of refinement of a liquid crystal material, the state of interfaces, and the like. To alleviate image sticking, a method of mitigating image sticking as thus described has been proposed as follows. A timer and an optical sensor are provided to measure and detect elapsed time and the brightness of the environment of a screen, and the screen is put in a standby state (the display is turned off) depending on detection results to prevent image sticking (e.g. see Japanese Patent Application Publication No. 2004-4200).

It is understood that a cholesteric liquid crystal is subjected to a higher degree of image sticking as the ambient temperature of the same becomes high. Another method has been proposed as follows based on this understanding. The ambient temperature of a liquid crystal display element is acquired. When a temperature increase or temperature change in unit time greater than a predetermined value is detected, image sticking is prevented by putting the screen in a standby state or displaying an image sticking preventing pattern using the focal conic state in which the entire screen is rendered black (e.g. see Japanese Patent Application Publication No. 2004-219715).

Another proposed approach to the prevention of image sticking is as follows. While an image is displayed in a memorized display mode, refreshing (rewriting) is carried out each time a predetermined time interval passes by executing a sequence of applying a voltage to the cholesteric liquid crystal to align the cholesteric liquid crystal substantially parallel to the voltage applying direction and thereafter re-displaying the image which has been displayed (e.g. see Japanese Patent Application Publication No. 2002-139746).

### SUMMARY

According to an aspect of the present invention, there is provided a display including: an image data storage unit that stores image data; a display image data generation unit that synthesizes the image data with data of a noise pattern image with no correlation to the image data, and generates display image data; and a display unit that displays an image based on the display image data generated by the display image generation unit, and maintains a display without power supply.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a schematic configuration of a liquid crystal display element;

FIG. 2 is a diagram schematically illustrating a structure (cross-section structure) of a display unit in FIG. 1;

FIG. 3A and FIG. 3B are diagrams illustrating a display principle of cholesteric liquid crystals;

FIG. 4A through FIG. 4C are diagrams illustrating voltage response characteristics of cholesteric liquid crystals;

FIG. 5 is a diagram illustrating a display process to the display unit;

FIG. 6 is a diagram illustrating a voltage setting when resetting;

FIG. 7 is a diagram illustrating a voltage setting when writing grayscale;

FIG. 8A and FIG. 8B are diagrams illustrating a display state of the display unit when image sticking occurs;

FIG. 9A is a diagram schematically illustrating a noise pattern image, and FIG. 9B is a diagram schematically illustrating image data;

FIG. 10 is a diagram illustrating the identifiability of image sticking in response to display images of which gray levels are different from each other;

FIG. 11 is a diagram illustrating a relation between the amount of image sticking and the average reflection ratio of the display image;

FIG. 12 is a diagram illustrating a relation between pixel values of a display image (8 bits (256 gray levels)) and noise strengths corresponding to pixel values;

FIG. 13 is a flowchart illustrating a process of synthesizing the display image with a noise pattern and displaying the synthesized image;

FIG. 14A and FIG. 14B are diagrams illustrating evaluation standards for an improvement in image sticking and the degree of granularity;

FIG. 15 is a diagram illustrating results of subjective evaluation;

FIG. 16 is a diagram illustrating results of subjective evaluation;

FIG. 17 is a diagram illustrating a liquid crystal display element capable of color display;

FIG. 18A through FIG. 18C are diagrams illustrating a method of synthesizing noise patterns in the liquid crystal display element in FIG. 17; and

FIG. 19 is a diagram illustrating blue noise.

### DESCRIPTION OF EMBODIMENTS

As described previously, multiple methods for preventing image sticking are proposed. However, in the case of the methods of preventing image sticking by setting a display screen in a standby state or displaying an image sticking prevention pattern on a display screen, a memorized display state must be once terminated to execute such methods. As a result, the liquid crystal display element needs a long time to recover from the standby state or the state of displaying an image sticking prevention pattern and to display the image which has been displayed in the memorized state of display again.

In the case of the method of preventing image sticking by carrying out refreshing by temporarily interrupting a memorized state of display each time a predetermined time interval passes, the liquid crystal display element will consume electric power for the refreshing operation. Further, the display of an image may be interrupted by the refreshing operation while the user of the liquid crystal display element is viewing the screen.

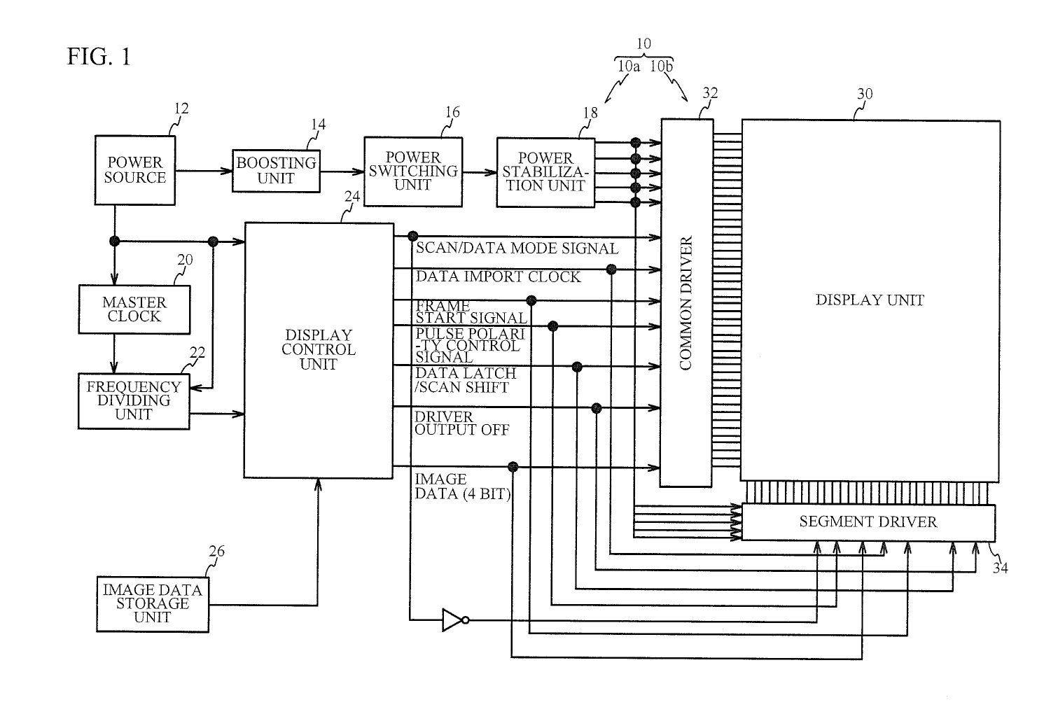

A description will now be given of an embodiment of a present invention with reference to FIG. 1 through FIG. 16.

In FIG. 1, a schematic configuration of a liquid crystal display element 10 as a display utilizing cholesteric liquid crystals capable of memory-displaying an image without power supply is illustrated by a block diagram. The liquid crystal display element 10 in FIG. 1 is a liquid crystal display element displaying a monochrome image.

The liquid crystal display element 10 is provided with a circuit block 10a and a display block 10b. The circuit block 10a includes a power source 12, a boosting unit 14, a power switching unit 16, a power stabilization unit 18, a master clock 20, a frequency dividing unit 22, a display control unit 24 as a display image data generation unit, and an image data storage unit 26. The display block 10b includes a display unit 30, a scan electrode drive circuit (common driver) 32, and a data electrode drive circuit (segment driver) 34.

The power source 12 outputs a DC voltage ranging from 3 to 5 V. The boosting unit 14 includes a DC-DC converter for example, and boosts the DC voltage ranging from 3 to 5 V inputted from the power source 12 to a DC voltage in a range from about 10 to about 40 V required for driving the display unit 30. The boosting unit 14 of which the conversion efficiency to the characteristics of the display unit 30 is high is preferable to be used. The power switching unit 16 generates necessary multi level voltages which depend on a gray level value of each pixel and depend on whether each pixel is selected or not using the voltage boosted by the boosting unit 14 and the input voltage. The power stabilization unit 18 includes a zener diode, an operation amplifier and the like. It stabilizes voltages generated by the power switching unit 16, and supplies them to the common driver 32 and the segment driver 34 provided to the display block 10b. The power source 12 supplies predetermined voltages to the display control unit 24, the master clock 20, and the frequency dividing unit 22 in addition to the boosting unit 14. The frequency dividing unit 22 divides the clock input from the master clock 20 with given frequency dividing rate and outputs it to the display control unit 24 to switch scan speed.

The display control unit 24 includes a processor and the like, and controls a whole of the liquid crystal display element 10. The display control unit 24 displays an image by switching scan speed and a drive voltage (drive pulse) of the display unit 30 via the common driver 32 and the segment driver 34, and executes a reset process of a display region.

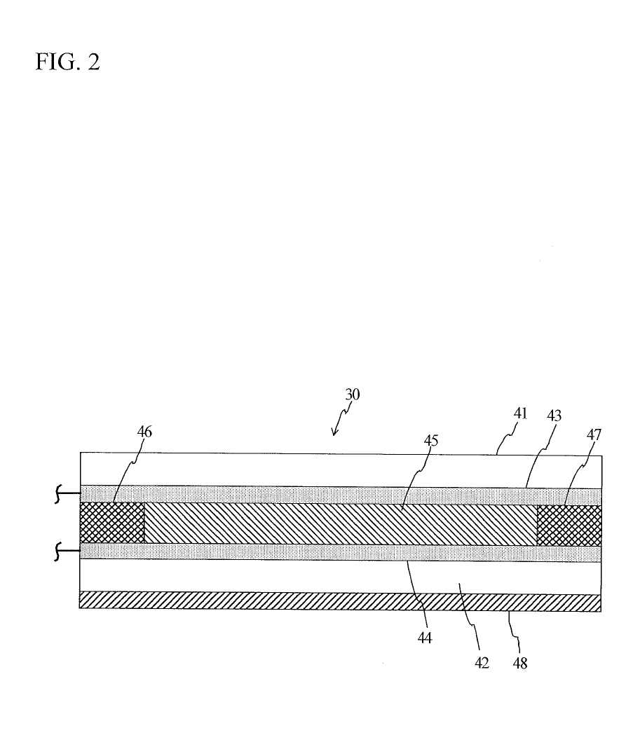

More specifically, the display control unit 24 controls the display unit 30 with a line-sequential drive system which scans linear electrodes 43 and 44 aligned at almost equal interval in the display unit 30 (see FIG. 2). The display control unit 24 controls the scan speed of the common driver 32 to change the application period for which a voltage of the drive pulse is applied. The display control unit 24 controls the segment driver 34 to be synchronized with a scan timing of the common driver 32 and to output a given voltage based on the image data to the display unit 30.

The display control unit 24 synchronizes generated drive data with data read clock signal and outputs it to the common driver 32 and the segment driver 34. The display control unit 24 changes the scan speed by outputting the drive data to the common driver 32. Moreover, the display control unit 24 outputs control signals, such as scan/data mode signal, a data import clock signal, a frame start signal, a pulse polarity control signal, a data latch/scan shift signal, and a driver output off signal, to the common driver 32 and the segment driver 34.

FIG. 2 schematically illustrates a structure (cross section structure) of the display unit 30. As illustrated in FIG. 2, the display unit 30 is provided with film substrates 41 and 42, ITO electrodes 43 and 44, liquid crystal compositions 45, seal materials 46 and 47, and an absorbing layer 48.

Film substrates 41 and 42 have translucency. Glass substrates can be used as materials for film substrates 41 and 42, and film substrates such as PET (Polyethylene Terephthalate) and PC (Polycarbonate) may be also used.

ITO electrodes 43 and 44 are composed of multiple belt-like electrodes parallel-aligned. The ITO electrode 43 and the ITO electrode 44 are aligned as to cross each other at 90 degrees from the view of direction vertical to film substrates 41 and 42 (direction vertical to the paper surface of FIG. 2). A material to form ITO electrodes 43 and 44 is an Indium Tin Oxide (ITO). Alternatively, electrodes using a transparent conductive film made of an Indium Zinc Oxide (IZO) may be used.

A thin film with insulation properties is formed on ITO electrodes 43 and 44. When this insulating thin film is thick, the rise of the drive voltage occurs, and a control by a general STN driver becomes difficult. On the other hand, if the insulating thin film is not provided, the leakage current flows, and the power consumption increases. The relative permittivity of the insulating thin film is around 5, and is lower than that of liquid crystals. Thus, it is preferable that the thickness of the insulating thin film is less than 0.3 μm. An SiO2 thin film and an organic film, such as polyimide resin and acryl resin which are well known as an alignment stabilization film, may be used as this insulating thin film.

Liquid crystal compositions 45 are cholesteric liquid crystal compositions exhibiting a cholesteric phase at room temperature.

Assume that liquid crystal compositions 45 are cholesteric liquid crystals made by adding 10 to 40 wt % of chiral materials to nematic liquid crystal compositions. The additive amount of chiral materials represents the value in a case where the sum of nematic liquid crystal compositions and chiral materials is 100 wt %. Materials conventionally known can be used as nematic liquid crystals, but it is preferable that its dielectric constant anisotropy (Δε) is in a range from 15 to 35. If the dielectric constant anisotropy is equal to or greater than 15, the drive voltage becomes relatively low, and if it exceeds 35, the drive voltage itself is low but the specific resistance becomes small, and the power consumption at high temperature especially increases. Moreover, it is preferable that the refractive index anisotropy (Δn) is in a range from about 0.18 to about 0.24. When the refractive index anisotropy is smaller than the value in this range, the reflection ratio in a planer state becomes low, and when it is greater than the value in this range, the scattering reflection in a focal conic state becomes large. As this makes the viscosity thick, the response speed is reduced.

Seal materials 46 and 47 seal liquid crystal compositions 45 between film substrates 41 and 42.

The absorbing layer 48 is located on the back side of the film substrate 42 which is the opposite side (the downside of the paper in FIG. 2) of the side to which the light enters (the upper side of the paper in FIG. 2).

A spacer may be provided to the display unit 30 to keep the gap between film substrates 41 and 42 evenly. A spherical object made of resin or inorganic oxide can be used as this spacer. Moreover, a fixed spacer of which the surface is coated with thermoplastic resin may be used as the spacer. It is preferable that the gap formed by the spacer is in a range from 3.5 to 6 μm for example. When the gap is smaller than the value in this range, the reflection ratio decreases and the display becomes dark. When the gap is greater than the value in this range, a drive voltage rises and the drive by general-purpose components becomes difficult.

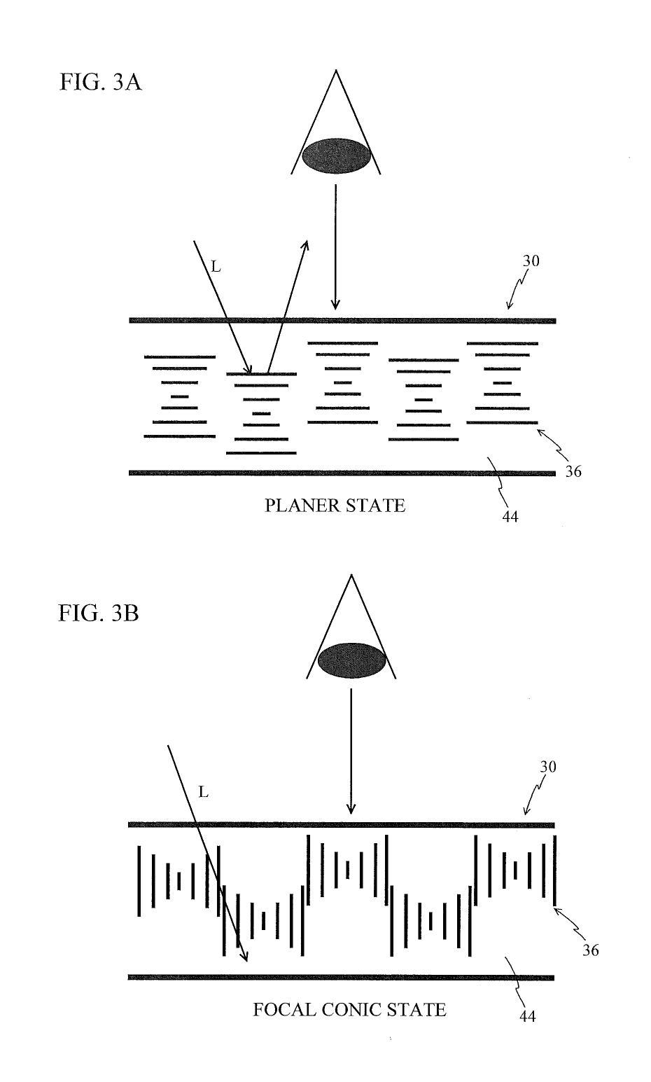

Here, a description will be given of the display principle of cholesteric liquid crystals based on FIG. 3A and FIG. 3B. FIG. 3A illustrates the orientational state of liquid crystal molecules 36 in a case where liquid crystal compositions 45 of the display unit 30 are in a planer state. FIG. 3B illustrates the orientational state of liquid crystal molecules 36 in a case where liquid crystal compositions 45 of the display unit 30 are in a focal conic state.

As illustrated in FIG. 3A, in a planar state, the liquid crystal molecules 36 are sequentially rotated in the thickness direction to form helical structures, and helical axes of the helical structures are substantially perpendicular to substrate surfaces. In a planar state, incident light L having predetermined wavelengths in accordance with the helical pitch of the liquid crystal molecules is selectively reflected by the liquid crystal layer. When assuming that the average refractive index of the liquid crystal layer is n and the helical pitch is p, the wavelength λ with which the reflection becomes maximum is expressed with a following formula (1).

λ=n·p (1)

Therefore, to reflect the light selectively in liquid crystal compositions 45 of the display unit 30 in a planer state, the average refractive index n and the helical pitch p are determined so that λ becomes a given value. The average refractive index n can be adjusted by selecting the liquid crystal material and the chiral material, and the helical pitch p can be adjusted by adjusting the chiral material content.

On the other hand, as illustrated in FIG. 3B, in a focal conic state, liquid crystal molecules 36 are sequentially rotated in an in-plane direction of substrates to form helical structures, and helical axes are substantially parallel to the substrate surfaces. In this case, the display unit 30 loses the selectivity of wavelengths to be reflected, and transmits most of the incident light L.

As described above, in the cholesteric liquid crystal, it is possible to control the reflection/transmission of the incident light L with the orientational state of helically-twisted liquid crystal molecules 36. In addition, in the display unit 30, when the incident light L is transmitted, as the transmitted light is absorbed in the absorbing layer 48 illustrated in FIG. 2, the dark display is achieved.

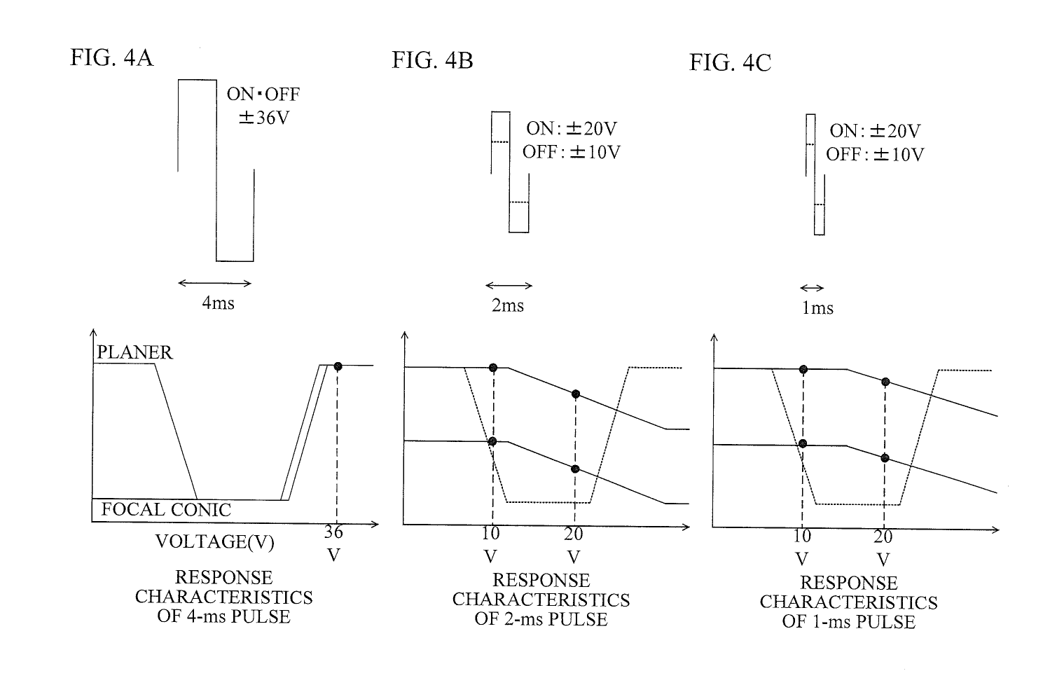

Voltage response characteristics of cholesteric liquid crystals are illustrated in FIG. 4A through FIG. 4C. When cholesteric liquid crystals are driven by a dot matrix, the drive waveform is alternating-current waveform to suppress the deterioration of the liquid crystal material in the same manner as general liquid crystals.

As illustrated in FIG. 4A, if the initial state is a planer state, the driving band for a focal conic state is achieved when the pulse voltage is raised to a certain range, and the driving band for a planer state is again achieved when the pulse voltage is further raised. Moreover, if the initial state is a focal conic state, the driving band for a planer state is gradually achieved as the pulse voltage is raised. In this case, when the initial state is either a planer state or a focal conic state, the voltage achieving a planer state is ±36 V. Therefore, the intermediate gray level where a planer state and a focal conic state coexist can be obtained at the voltage between −36 V and +36 V.

On the other hand, when the pulse of which the voltage is lower than that of FIG. 4A or of which the period is shorter than that of FIG. 4A is applied, the responsiveness shifts. For example, if the applied pulse is the pulse of which the applied voltage is ±20 V or ±10 V and of which the period is 2 ms or 1 ms, and the initial state is a planer state, the responsiveness does not appear in either cases where the period is 2 ms (FIG. 4B) or the period is 1 ms (FIG. 4C) when the voltage is ±10 V, and a planer state is maintained. On the other hand, when the voltage is ±20 V, in both cases where the period is 2 ms and the period is 1 ms, the responsiveness appears, and the intermediate gray level where the reflection ratio slightly decreases is achieved. As the descent of the reflection ratio when the period is 1 ms is greater than that when the period is 2 ms as understood from the comparison between FIG. 4B and FIG. 4C, the gray level when the period is 2 ms becomes lower than that when the period is 1 ms.

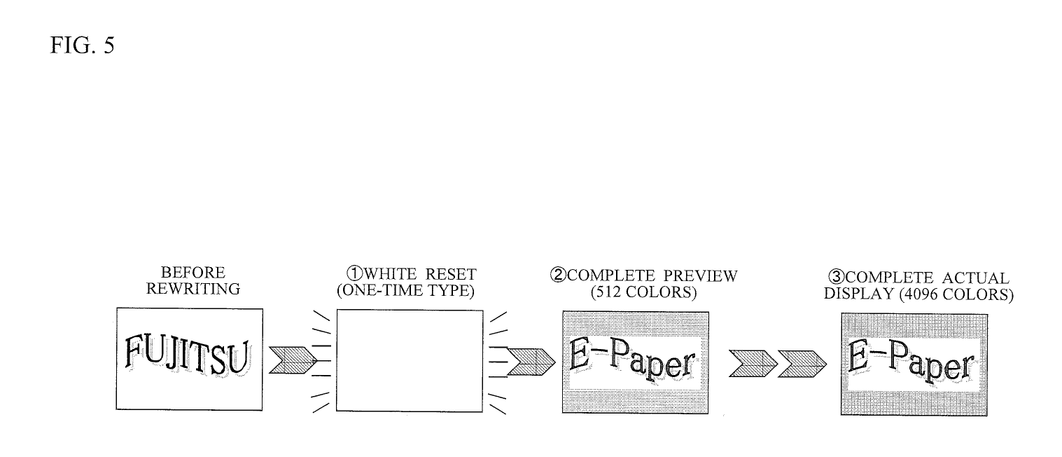

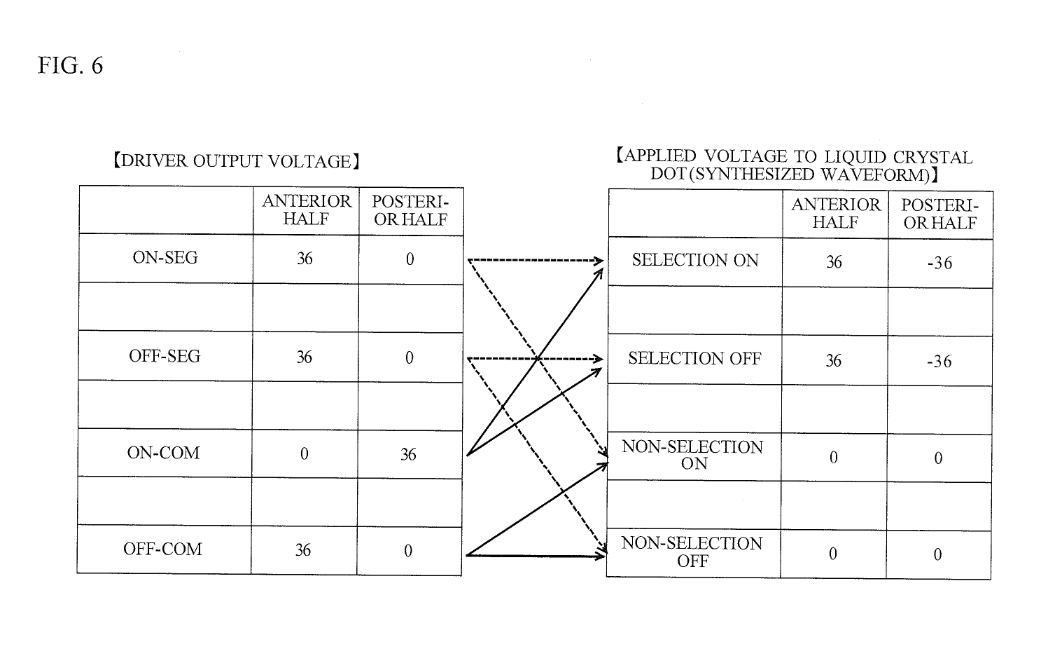

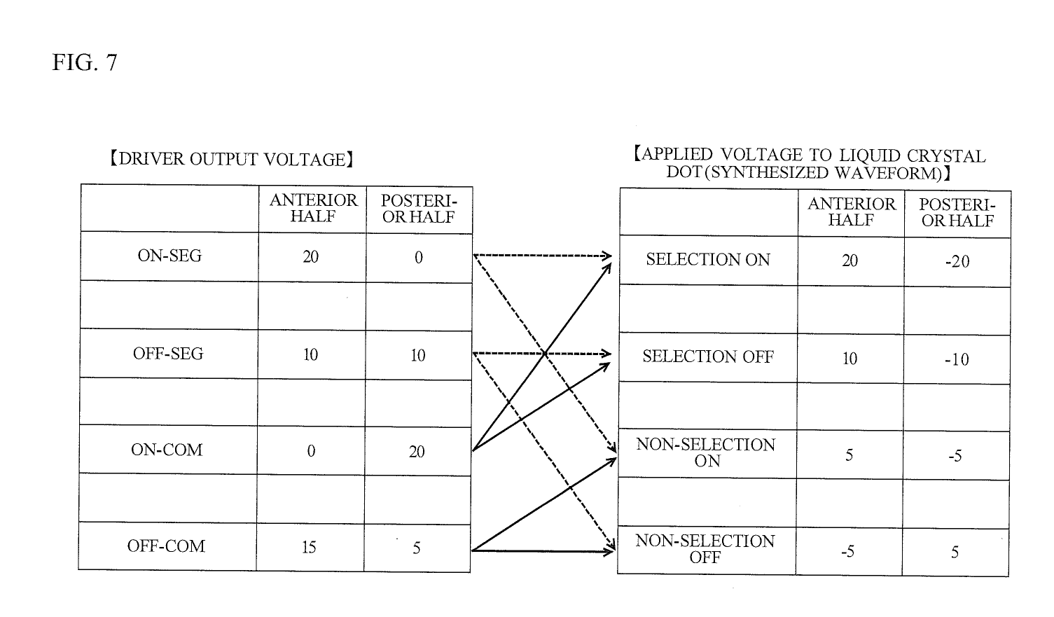

Here, in this embodiment, when carrying out a display to the display unit 30, a desired image is drawn by increasing the ratio of a focal conic state after resetting the pixels to be rewritten to the planer state (white reset) as illustrated in FIG. 5. When a reset is carried out, the voltage setting illustrated in FIG. 6 is carried out. As ±36 V is applied to the selected line with the voltage setting illustrated in FIG. 6, the selected line is reset to a planer state. In addition, when writing grayscale, the voltage setting illustrated in FIG. 7 is carried out. In this case, when writing desired gray level at ±20 V, ±20 V is applied to pixels where scan-side is selected and data-side is ON, ±10 V is applied to pixels where scan-side is selected and data-side is OFF, and ±5 V is applied to pixels where scan-side is not selected. Here, in pixels to which ±10 V or ±5 V is applied, gray levels are not newly formed.

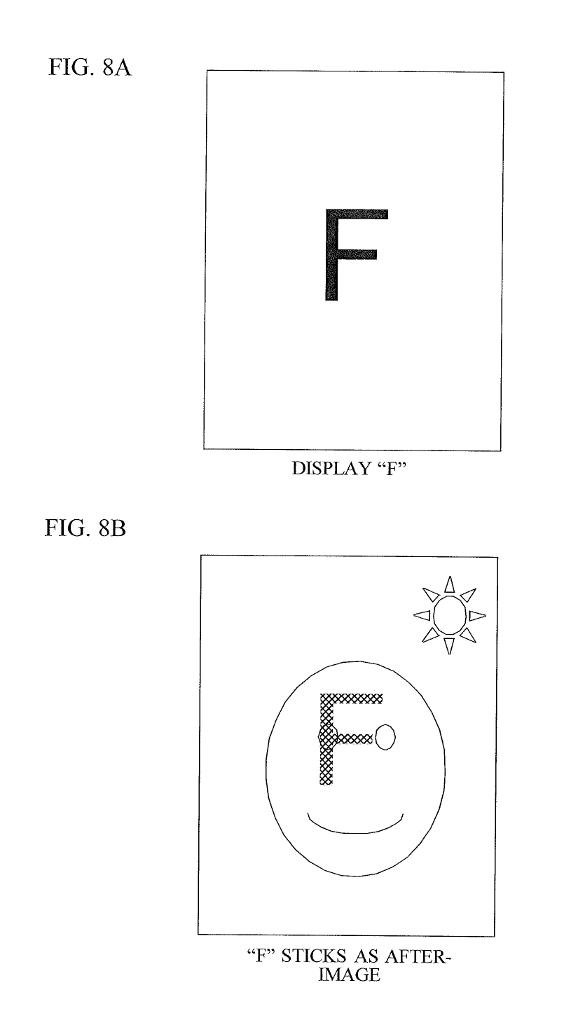

A description will now be given of the display method of the image to the display unit 30 in this embodiment with reference to FIG. 8 through FIG. 13. Hereinafter, the pixel value of each pixel constituting the display unit 30 is digital value on 8-bit operation (0 through 255), and the gray level is defined as the number of color levels (256 gray levels at 8 bits, 0 represents black, 255 represents white, and values between 0 and 255 represent grayscale).

In this embodiment, when the image is switched after the alphabet “F” is displayed on the display unit 30 for long period of time, the display method to obscure the image sticking of the alphabet “F” is carried out as illustrate in FIG. 8A.

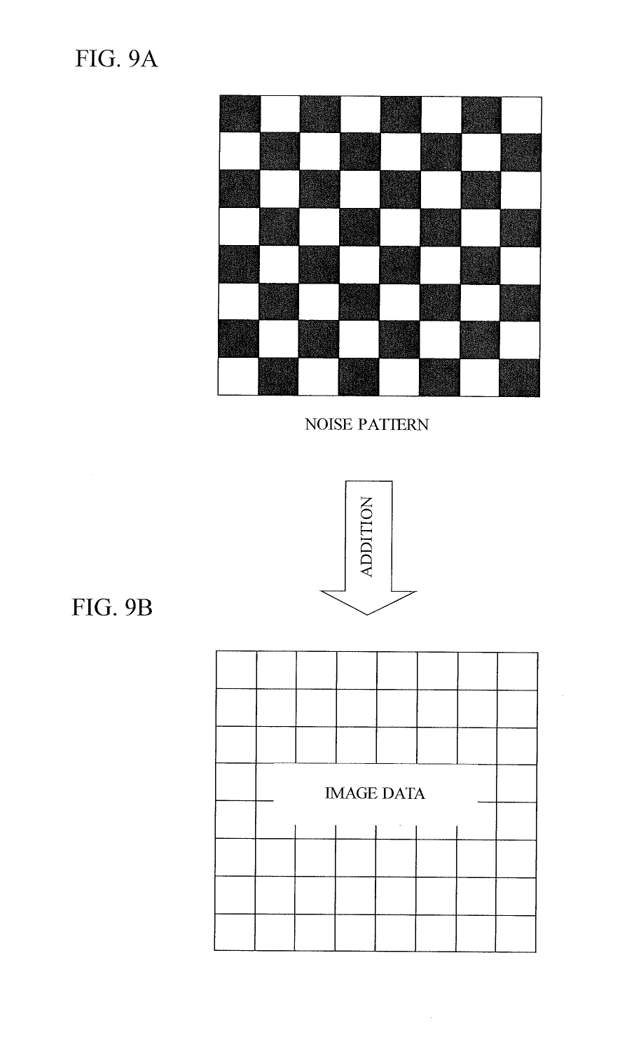

More specifically, the display control unit 24 in FIG. 1 synthesizes a noise pattern image illustrated in FIG. 9A with an image to be displayed illustrated in FIG. 9B (an image stored in the image data storage unit 26), which means that the data of noise pattern image is added to the data of image to be displayed, and displays the synthesized image generated by above process on the display unit 30.

Here, the noise pattern image is a periodic noise pattern (check pattern) with no correlation to the image to be displayed, and the noise pattern has high frequency (0.5 cycle/pixel). In addition, in FIG. 9A, for convenience sake of illustration, the noise pattern image is a monochrome pattern, but has imperceptible amplitude from less than one gray level to several gray levels at a maximum. For example, in the noise pattern illustrated in FIG. 9A, areas indicated by “black” have amplitude of 0 (gray level), and areas indicated by “white” have amplitude of 1 (gray level). The amplitude may be a combination of −1 and 0, or a combination of −1 and 1 instead of a combination of 0 and 1. In addition, it is not necessary to be binary, and the noise pattern composed of combination of three values or four values may be used.

Even though the noise pattern is synthesized, as the noise pattern is very small, the disturbance of the image which affects on the visibility does not occur.

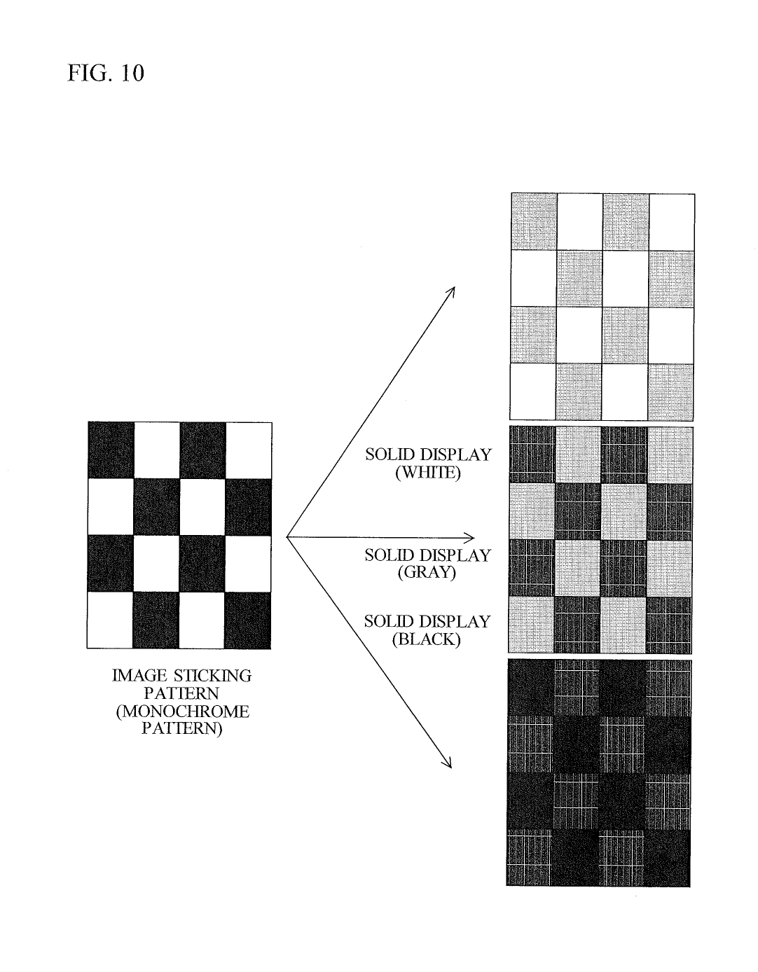

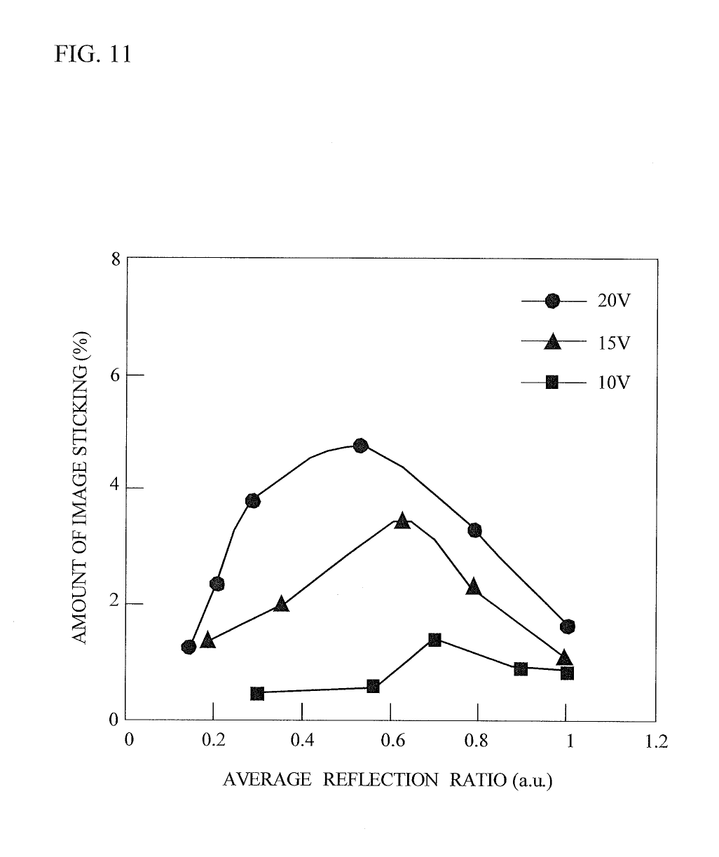

Here, the identifiability of image sticking depends on gray levels of image to be displayed. More specifically, when a white, gray, or black solid pattern without spaces is displayed on the display unit 30 after the monochrome pattern illustrated in FIG. 10 is purposely displayed for several days, the monochrome pattern is identified as a sticking image, but the amount of image sticking (degree of identifiability of the sticking image) is different with respect to the gray levels of solid pattern. When the identifiability of the sticking image (amount of image sticking) is expressed by the difference between the bright region and the dark region, the result illustrated in FIG. 11 is obtained. In FIG. 11, the amount of image sticking is expressed in percentage (%) by dividing the difference between the bright region and the dark region by the total number of gray levels (256).

According to the graph in FIG. 11, as the pixel value of the image to be displayed is closer to the value of intermediate gray level (gray), the amount of image sticking tends to be larger. As the pixel value is closer to the value of white (highlight) or black (shadow), the amount of image sticking tends to be smaller. Therefore, in this embodiment, it is preferable that amplitudes of the gray level values of the noise pattern are made larger as pixel values of the image to be displayed are closer to the value of intermediate gray level, and it is preferable that amplitudes of gray level values of the noise pattern are made smaller as pixel values of the image to be displayed are closer to the value of highlight or shadow.

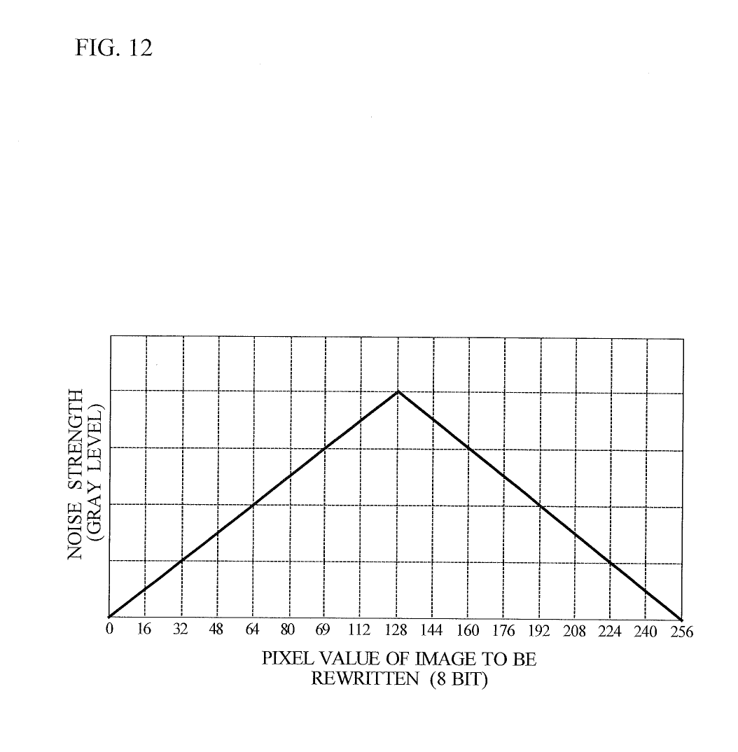

FIG. 12 illustrates a relation between pixel values of the display image (8 bits (256 gray levels)) and noise strengths corresponding to pixel values. As illustrated in the graph of FIG. 12, based on the amount of image sticking illustrated in FIG. 11, the amplitude of the gray level value of the noise pattern takes peak at the intermediate gray level, and as the pixel value of the image to be displayed is closer to the white (255) or black (0), the amplitude of gray level value of the noise pattern is made smaller.

A description will now be given of the method of synthesizing the noise pattern with the image to be displayed using the relation described in FIG. 12.

When the data of the image to be displayed is expressed by Img_org[x, y], and the data of noise pattern image is expressed by Noise_pattern[x, y] (binary), the amplitude of gray level value of the noise pattern (Noise_amp[x, y]) is obtained by a following formula (2).

Noise_amp[x, y]=abs[abs(Img_org[x, y]−128)−128]×Const (2)

Here, abs means an absolute value, and Const means a constant. According to the formula (2), as Img_org[x, y] is closer to 128, the value of Noise_amp[x, y] becomes larger. The magnitude of the gray level value of noise is determined by the constant Const.

In addition, data of the noise pattern image conclusively used (noise pattern image of which the amplitude of gray level value is finally determined) (Noise_final[x, y]) is obtained by a following formula (3).

Noise_final[x, y]=Noise_amp[x, y]×Noise_pattern[x, y] (3)

Furthermore, the data of the synthesized image (Img_final[x, y]) which is generated by adding the data of the noise pattern image to the data of the image to be displayed is obtained by a following formula (4).

Img_final[x, y]=Img_org[x, y]+Noise_final[x, y] (4)

Here, it is not necessary to extract the noise pattern (Noise_pattern[x, y]) on the memory. If the noise pattern is a periodic pattern, its formula can be used, and if it is a random pattern, a formula generating its random numbers can be used.

Moreover, to prevent the image sticking of the noise pattern itself on the display unit 30, it may be possible to shift the phase of the noise pattern every time when the screen is rewritten or every time when the screen is rewritten predetermined number of times.

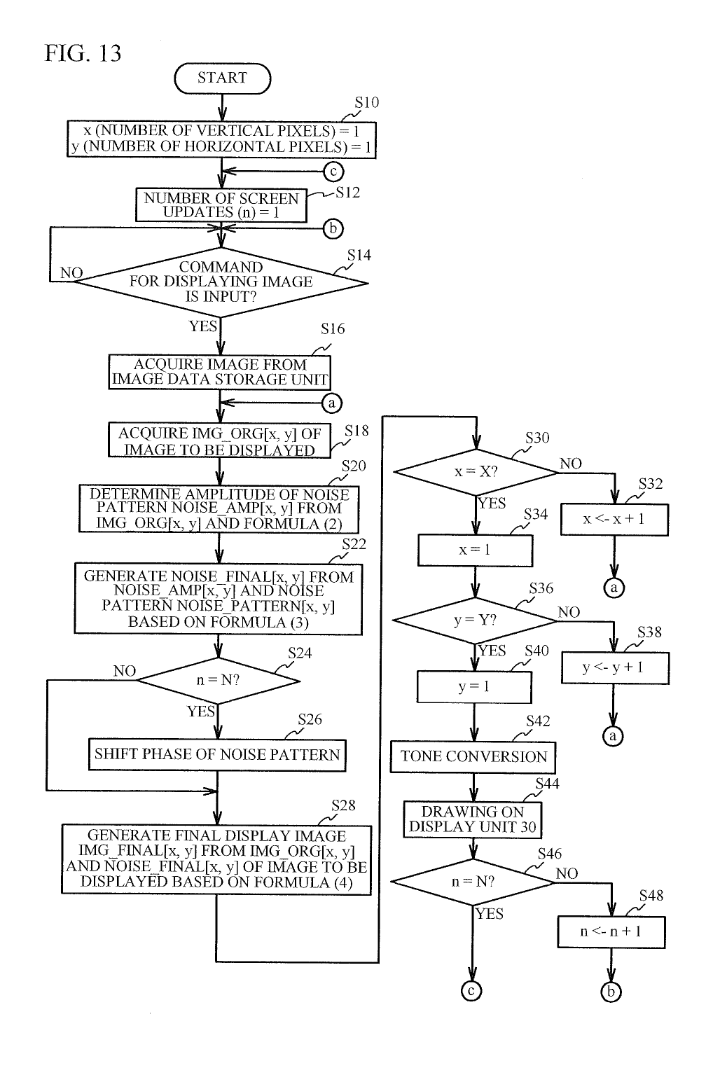

FIG. 13 illustrates a flowchart related to the process for generating a synthesized image by synthesizing the image to be displayed with the noise pattern image and displaying the synthesized image. The process of this flowchart is executed by the display control unit 24.

In a step S10, the display control unit 24 sets the variable number x indicating the number of vertical pixels to 1, and sets the variable number y indicating the number of horizontal pixels to 1.

Then, the display control unit 24 sets the variable number n indicating the number of screen updates in a step S12.

In a step S14, the display control unit 24 stands by until the command for displaying an image is input. When the command for displaying an image is input, the display control unit 24 acquires the image corresponding to the command from the image data storage unit 26 in a step S16.

Then, the display control unit 24 acquires the data of the image to be displayed Img_org[x, y] (here, Img_org[1, 1]) in a step S18.

Then the display control unit 24 determines the amplitude of gray level value of the noise pattern Noise_amp[x, y] (here, Noise_amp[1, 1]) from Img_org[x, y] (here, Img_org[1, 1]) based on the above formula (2) in a step S20.

Then, the display control unit 24 generates the data of the final noise pattern Noise_final[x, y] (here, Noise_final[1, 1]) from the amplitude of gray level value of the noise pattern Noise_amp[x, y] (here, Noise amp[1, 1]) and the data of the noise pattern image Noise_pattern[x, y] (here, Noise_pattern[1, 1]) based on the above formula (3) in a step S22.

In a step S24, the display control unit 24 determines whether n is a maximum value N of n which is preliminarily determined. Here, as n is equal to 1, the determination is NO, and the process moves to a step S28. When the n is equal to N, as the determination of the step S24 is YES, the display control unit 24 shifts the phase of the noise pattern in the step S26, and the process moves to the step S28.

The display control unit 24 generates the data of the final display image (synthesized image) Img_final[x, y] (here, Img_final[1, 1]) from the data of image to be displayed Img_org[x, y] (here, Img_org[1, 1]) and Noise_final[x, y] (here, Noise_final[1, 1]) based on the above formula (4) in the step S28.

Then, in a step S30, the display control unit 24 determines whether x is a maximum value X of x preliminarily determined. Here, the maximum value X means the total number of pixels aligned in the vertical direction on the display unit 30. When the determination of the step S30 is NO, the process moves to a step S32, and the display control unit 24 increments x by 1, and goes back to the step S18. Then, the display control unit 24 executes the step S18 through step S28, and generates Img_final[2, 1] from Img_org[2, 1]. When the determination of the step S30 is NO again, the display control unit 24 increments x by 1 again in the step S32 and goes back to the step S18. After that, above procedures are repeated until Img_final[3, 1] through Img_final[X, 1] are obtained, and when the determination of the step S32 becomes YES, the process moves to the step S34. The display control unit 24 sets x to 1 in the step S34. Then, in a step S36, it determines whether y is a maximum value Y of y preliminarily determined. Here, the maximum value Y means the total number of pixels aligned in the horizontal direction on the display unit 30. When the determination of the step S36 is NO, the process moves to the step S38, and the display control unit 24 increments y by 1 and goes back to the step S18. After this process, the step S18 through step S32 are repeated, and Img_final[1, 2] through Img_final[X, 2] are obtained.

Above procedures are repeated, and when the display control unit 24 obtains Img_final[X, Y], the determination of the step S36 becomes YES, and the process moves to a step S40. In the next step S40, the display control unit 24 sets y to 1. Then, the display control unit 24 executes the gray level conversion process using obtained Img_final[1, 1] through Img_final[X, Y] and carries out the drawing on the display unit 30 in the step S44.

Then, in a step S46, the display control unit 24 determines whether n is N. When the determination of the step S46 is NO, n is incremented by 1 in a step S48, and the process goes back to the step S14. On the other hand, when n is N, the determination of the step S48 becomes YES, and the process goes back to the step S12.

As the display control unit 24 executes above procedures, the image (synthesized image) where the image to be displayed is synthesized with the noise pattern image of which the amplitude of gray level value is changed according to the image to be displayed is generated, and the generated image can be displayed on the display unit 30.

In the above description, the case where Noise_amp[x, y] is calculated with the formula (2) was presented, but does not limit the present invention. For example, the display control unit 24 may preliminarily hold a table relating values of Img_org[x, y] and values of Noise_amp[x, y] corresponding to Img_org[x, y], and may determine Noise_amp[x, y] with this table. This makes it possible to improve the speed of display process.

Here, a description will be given of results of verification of the effect by execution of the above display.

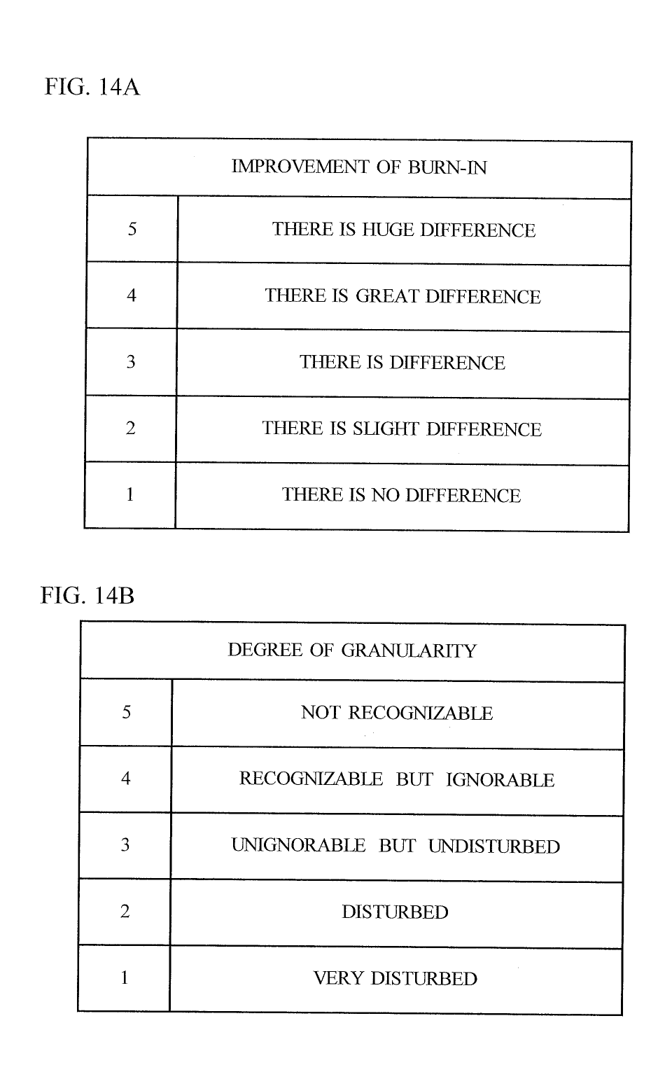

In this embodiment, to verify the effect quantitatively, the subjective evaluation by human is carried out. The evaluation items of this subjective evaluation are two, which are (i) the improvement in image sticking and (ii) the degree of granularity, and a five-score evaluation is carried out for each item. The evaluation standards for this case are indicated in FIG. 14A and FIG. 14B. FIG. 14A indicates the evaluation standard for the improvement in image sticking, and when the degree of improvement in image sticking is high, the score becomes high. FIG. 14B indicates the evaluation standard for the degree of granularity, and the larger the score is, the higher the granularity is (the smaller the image roughness is).

Five images, which are “intermediate gray level solid image 1”, “intermediate gray level solid image 2”, “person image 1 (solid area is large)”, “person image 2 (solid area is small)”, and “animation image (solid area is small)”, are used as evaluation images. Moreover, in the evaluation, the display area of the display unit 30 is divided into two equal area, and identical images (e.g. image of alphabet “F” illustrated in FIG. 8) are displayed in both areas for long period of time. Then the evaluation image is displayed in one area, the image made by synthesizing the evaluation image with the noise pattern is displayed in the other area, and both areas are compared.

In addition, a noise pattern added to the image data is a check fixed pattern, and 0.5/16 gray levels (= 2/64 gray levels, 8/256 gray levels), 1/16 gray levels (= 4/64 gray levels, 16/256 gray levels,) and 1.5/16 gray levels (= 6/64 gray levels, 24/256 gray levels) are used as the intensity (peak value).

The conversion procedures of number of displayed colors are executed in order of an original image (256 gray levels)+noise pattern (256 gray levels), a gray level conversion, a graphic image (16 gray levels), and data for drive circuit (binary). In this case, the organized dither method or the error diffusion method may be used as a conversion algorithm from 256 gray levels to 16 gray levels, but in this evaluation, a thinning process which is simple and of which the calculation amount is small is used to extract the effect of noise addition.

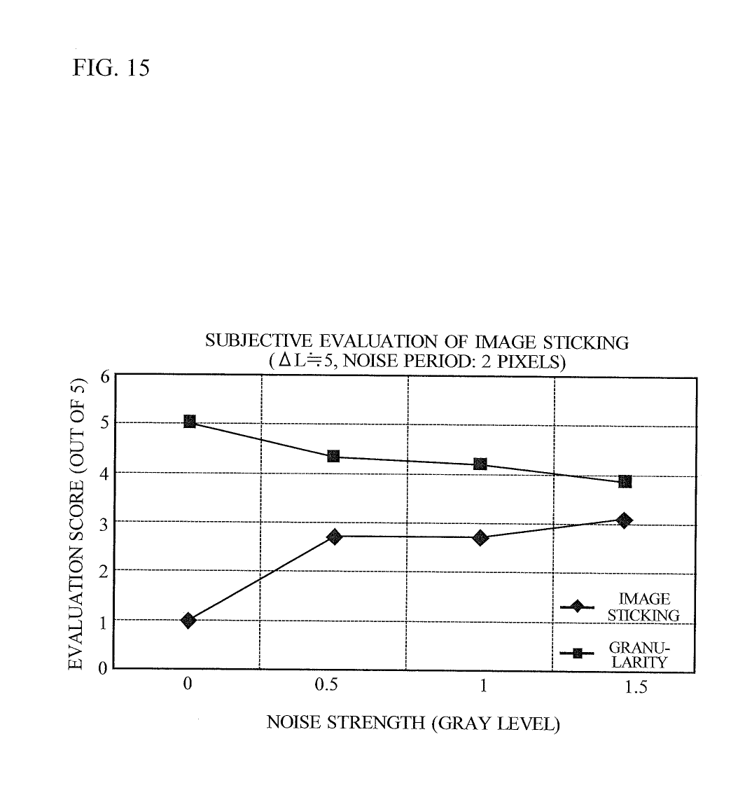

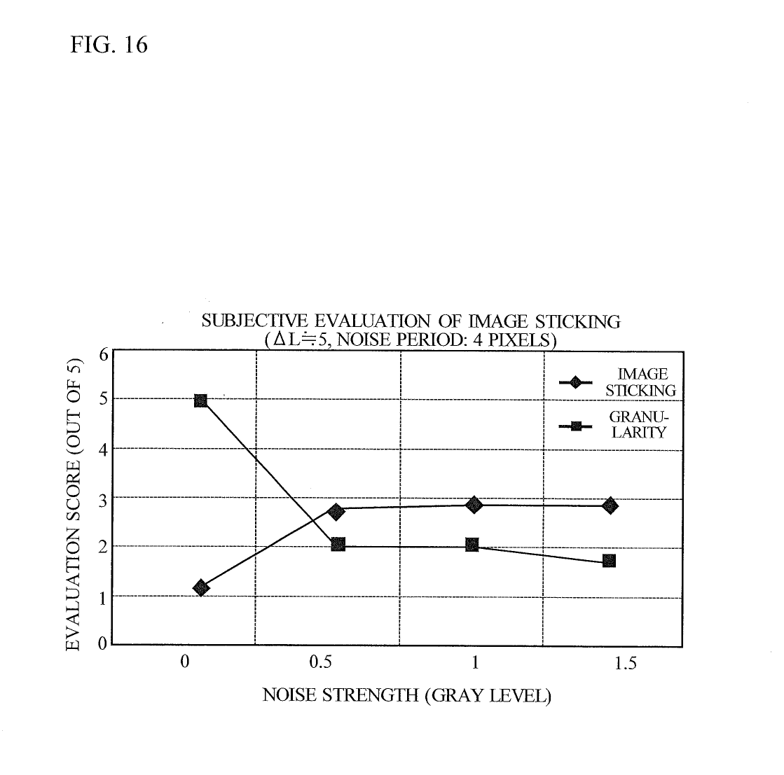

In FIG. 15 and FIG. 16 illustrates the result of subjective evaluation. In “person image 2 (solid area is small)” and “animation image (solid area is small)”, the change of gray levels is big in the picture itself, and the image sticking is not so clear. Thus, these results are omitted from the result of subjective evaluation.

FIG. 15 illustrates a case where the noise pattern has high frequency (maximum) (0.5 cycle/pixel), and FIG. 16 illustrates a case where the noise pattern has low frequency (0.25 cycle/pixel).

In FIG. 15, even in the case where small noise pattern such as 0.5/16 gray levels is added, the effect of improvement in image sticking can be observed. In addition, the evaluation of the granularity which is a trade off element of improvement in image sticking is slightly lower than that of the case where the noise pattern is not added. However, as the evaluation score is more than 4 (recognizable but ignorable), it is verified that there is not the practical issue.

Furthermore, if a noise strength is strengthen from 1/16 gray levels to 1.5/16 gray levels, the evaluation score of improvement in image sticking is further improved. In this case, the evaluation score of the degree of granularity slightly decreases, but there is not big difference from that of a case of 0.5/16 gray levels.

On the other hand, in FIG. 16, the evaluation score of improvement in image sticking is almost same as the case in FIG. 15, but it is verified that the evaluation score of degree of granularity greatly decreases. This means that when the noise pattern is made to have low frequency, the image roughness is relatively visually identifiable. Therefore, from these results, it is verified that it is preferable that noise pattern has high frequency.

If the organized dither method or the error diffusion method is used for the gray level conversion algorithm described above, the noise content is generated by the output pattern. However, even in this case, it is effective to synthesize the noise pattern as described in the present embodiment. For example, in a case of displaying 4096 colors or 260 thousands colors, as the noise content caused by the organized dither or error diffusion becomes small, the effect to obscure the image sticking visually does not appear in the noise content.

As described above, according to the present embodiment, as the display control unit 24 synthesizes an image stored in the image data storage unit 26 with a noise pattern with no correlation to this image data, and generates an image to be displayed (synthesized image), and the display unit 30 which can maintain the display without power supply displays the synthesized image. Therefore, even though the previous image is displayed for long period of time, it becomes possible that the image sticking image is not visually identifiable due to the visual effect of the noise pattern. This makes it possible to maintain a memory display state and to prevent the deterioration of display quality caused by image sticking.

In addition, according to the present embodiment, as the display control unit 24 changes amplitudes of gray level values of the noise pattern based on pixel values of the image to be displayed, it is possible to allow the image sticking image to be obscured by enhancing the visual effect of the noise pattern by increasing amplitudes of gray level values of the noise pattern in the area of pixel values where the image sticking is easily identified.

In addition, according to the present invention, as the display control unit 24 changes the phase of noise pattern in response to the number of generation of display image, it is possible to suppress the image sticking of the noise pattern itself to the display unit 30.

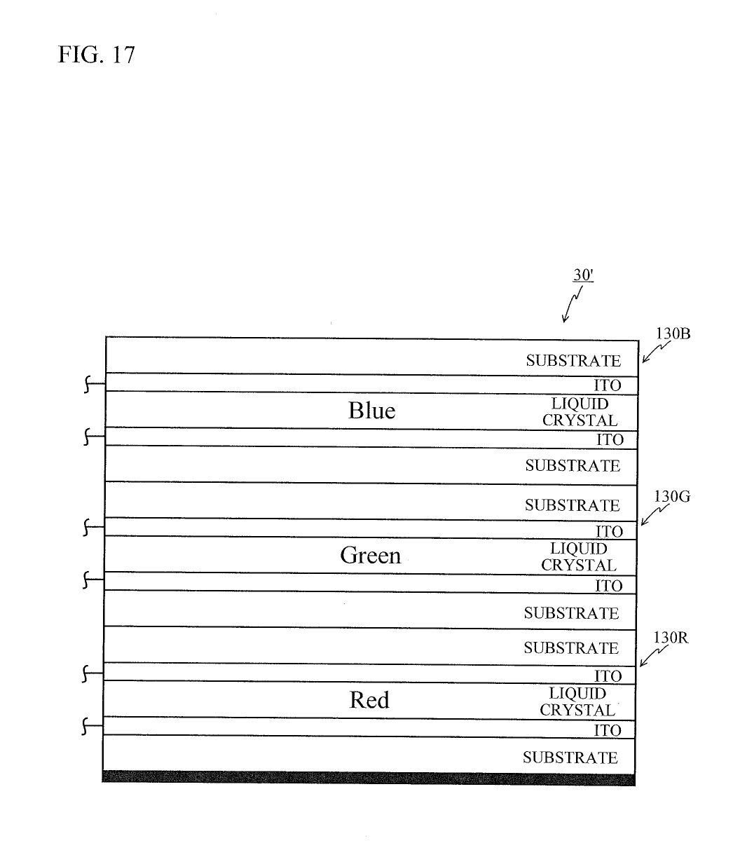

In the above embodiment, the description was given of the case where the liquid crystal display element 10 is the liquid crystal element that displays a monochrome image. However, the liquid crystal display element 10 may be a liquid crystal display element capable of color display. In this case, as illustrated in FIG. 17, the display unit 30′ of the liquid crystal display element is formed by stacking a blue (B) display unit 130B, a green (G) display unit 130G, and a red (R) display unit 130R. In the display unit 30′, as the image data given to each pixel of RGB is different, it is necessary to provide the segment drivers 34 for each of RGB.

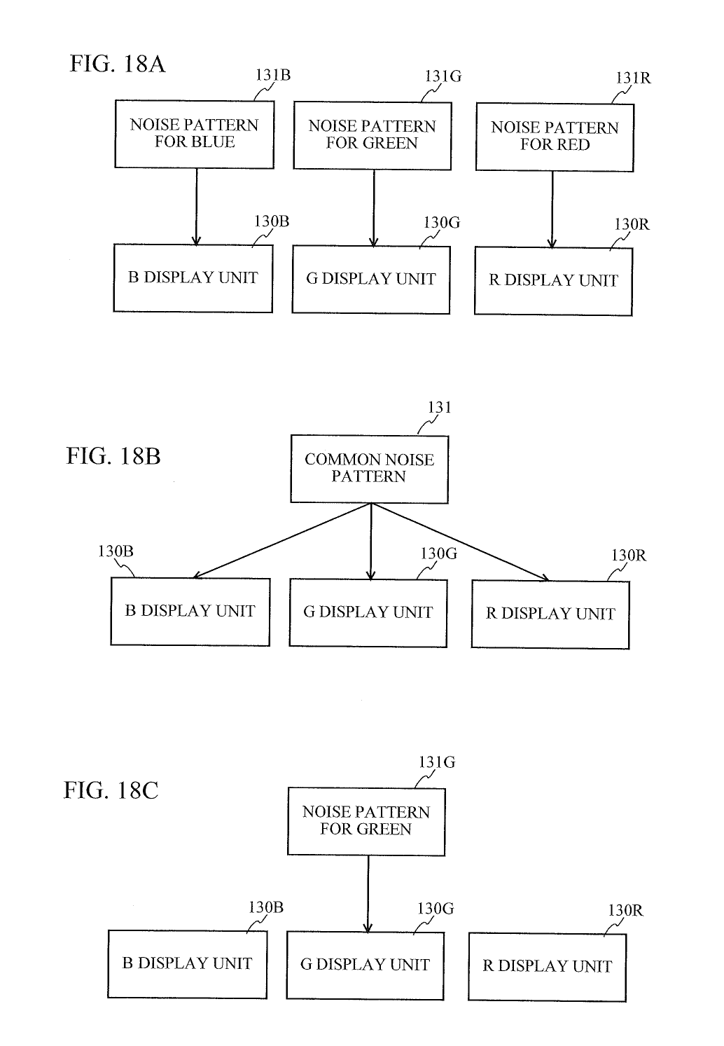

In this case, as illustrated in FIG. 18A, the display control unit 24 prepares a noise pattern 131B for Blue, a noise pattern 131G for Green, and a noise pattern 131R for Red corresponding to display units 130B, 130G and 130R respectively, and the images made by synthesizing these noise patterns can be displayed in respective display units. In this case, it is preferable that the noise strength of the color of which the visual appreciation is high is made strong. In the display unit 30′ in FIG. 17, the effect increases when the noise strength is set as “pattern 131G≧pattern 131R≧pattern 131B”.

Moreover, alternatively, as illustrated in FIG. 18B, the display control unit 24 may prepare a noise pattern common to display units 130B, 130G and 13R, and display images made by synthesizing this noise pattern on respective display units. Furthermore, as illustrated in FIG. 18C, the display control unit 24 may prepare only a noise pattern 131G for Green of which the visual appreciation is highest, and synthesize the noise pattern 131G for the G display unit 130G. In this case, the effect of the reduction of image sticking increases in order of FIG. 18C, FIG. 18B, and FIG. 18A, but the necessary process ability increases in order of FIG. 18C, FIG. 18B, and FIG. 18A.

In the above embodiment, the description was given of the case where a periodic pattern is used as a noise pattern, but a noise pattern is not limited to a periodic pattern. For example, it is possible to use a random noise pattern. Same effect as the periodic pattern can be obtained with the random noise pattern, but from the point view of degree of granularity, the use of a periodic pattern is more effective.

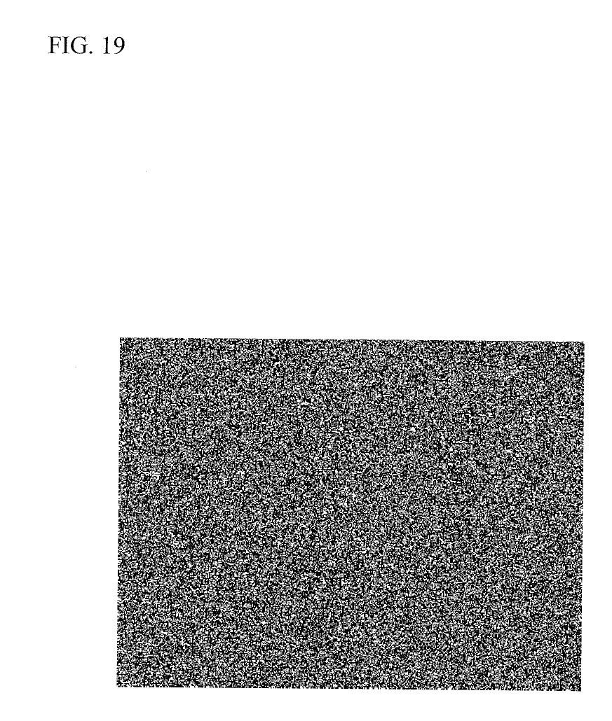

In addition, from the point view of the visual characteristics, it is verified that the discomfort by the granularity is not easily felt when a check pattern is used as the periodic pattern, or when the blue noise which has a weight on the high frequency side in the space frequency as illustrated in FIG. 19 is used as a random pattern.

In the above embodiment, as illustrated in FIG. 11, the description was given of the case where the image sticking increases as the gray level value of the image is closer to the value of intermediate gray level, but the case is not limited to above embodiment. When using a liquid crystal display element having a panel structure where image sticking increases when the gray level of the image is close to highlight (white) or shadow (black) compared to the gray level value of the image which is an intermediate value, the amplitude of the gray level value of the noise pattern added to the highlight or shadow may be controlled to be large.

In the above embodiment, the description was given of the case where amplitudes of gray level values of the noise pattern are changed in response to pixel values of the image to be displayed, but the amplitude may be a fixed value. In the above embodiment, the description was given of the case where the phase of noise pattern is changed in response to the number of updates of image, but a phase may be not changed.

In the above embodiment, the description was given of the case where the present invention is applied to the cholesteric liquid crystal, but the present invention may be applied to the display device capable of maintaining a display without power supply such as an electrophoresis system, electronic powder fluid, and the like.

In the above embodiment, the description was given of a case where the present invention is achieved by the liquid crystal display element 10 as a display including the display control unit 24 having a function synthesizing a noise pattern with an image, but the present invention can be achieved by a display control program which is installed in a computer system, and which causes a computer system to execute a process in FIG. 13.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various change, substitutions, and alterations could be made hereto without departing from the spirit and scope of the invention.

What is claimed is:

1. A display comprising:
an image data storage unit that stores image data;
a display image data generation unit that synthesizes the image data with data of a noise pattern image with no correlation to the image data, and generates display image data; and
a display unit that displays an image based on the display image data generated by the display image generation unit, and maintains a display without power supply.

2. The display according to claim 1, wherein the display image data generation unit changes amplitudes of gray level values of pixels of the noise pattern image based on pixel values of pixels of the image data corresponding to the pixels of the noise pattern image.

3. The display according to claim 2, wherein the display image data generation unit changes the amplitudes of gray level values of the noise pattern image more greatly in a case where the pixel values of the pixels of the image data represent an intermediate gray level than a case where the pixel values of pixels of the image data represent highlight or shadow.

4. The display according to claim 2, wherein the display unit displays a color image, and the amplitudes of the gray level values of the noise pattern relatively increase as a visual appreciation of a color increases.

5. The display according to claim 3, wherein the display unit uses a liquid crystal display forming a cholesteric phase.

6. The display according to claim 1, the display image data generation unit changes a phase of the noise pattern image in response to the number of generation of the display image data.

7. A computer readable medium storing a program causing a computer to execute a process, the process comprising:
generating display image data by synthesizing data of an image to be displayed with data of a noise pattern image with no correlation to the data of the image to be displayed; and
displaying an image on a display unit capable of maintaining a display without power supply based on the synthesized display image data.

8. The computer readable medium according to claim 7, wherein the process further comprises changing amplitudes of gray level values of pixels of the noise pattern image based on pixel values of pixels of the image data corresponding to the pixels of the noise pattern image.
